(19) United States
(12) Patent Application Publication
(10) Pub. No.: US 2011/0015957 A1
(43) Pub. Date: Jan. 20, 2011

(54) License Tracking System and Related Software for Complex License and Compliance Requirements

(76) Inventors: Annemaria Allen, Escondido, CA (US); Cynthia McClure, San Marcos, CA (US); Jason Farmer, San Marcos, CA (US)

Correspondence Address: BUCHALTER NEMER, 18400 VON KARMAN AVE., SUITE 800, IRVINE, CA, 92612, US

(21) Appl. No.: 12/505,349

(22) Filed: Jul. 17, 2009

(51) Int. Cl. G06Q 10/00; G06Q 40/00; G06F 15/16; G06F 17/30; G06F 17/40; G06F 3/048

(52) U.S. Cl. 705/7; 709/206; 715/780; 707/E17.044

(57) ABSTRACT

A license tracking system has been developed that comprises: a) at least one set of license requirements, b) at least one form, questionnaire, prompt series, survey interface or combination thereof that requests at least one piece of input data related to a licensee, the license requirements or a combination thereof from a user, c) at least one database that collects and compares the at least one set of license requirements and the at least one piece of input data to produce a set of compliance instances and a set of alert instances, d) a compliance notice component that provides the set of compliance instances to the user, and e) an alert notice component that provides at least one of the alert instances to the user. Methods of tracking licenses and license-related information have also been developed, along with network systems capable of executing software programs comprising license tracking software.

### FIELD OF THE SUBJECT MATTER

The field of the subject matter is a license tracking system and related software for complex license and compliance data and requirements.

### BACKGROUND

Licensing requirements for many industries can be difficult to track and outline complex compliance requirements. In addition, many licensing requirements require licensing on both the state and federal level more many industries, such as the mortgage, lending and real estate industries for both residential and commercial real estate. There are similar complex licensing requirements for professionals in the construction, design, architecture, legal and medical industries.

For example, mortgage licensing laws are complex, partly because each state has a unique set of laws, rules and regulations that relate to the mortgage and lending industries. Each state differs on whether a mortgage professional, lending professional and/or mortgage broker needs a mortgage license, whether the mortgage broker can loan on both first and second mortgages, or whether a physical office in the state is required. States also differ on how much continuing education they require of the mortgage brokers. The various mortgage licensing laws also pertain to the employees of the mortgage brokers, and whether they, too, need a mortgage license. So, if a mortgage broker has a large regional or national business, it can be a daunting task to initially comply with each state's requirement and possibly even more difficult to track changes over time in each state and comply as these rules and regulations change.

To this end, it would be desirable to secure a plurality of licenses, track, notify the licensee of updates and new requirements and aid the licensee in complying with those original and new requirements. It would also be ideal to have a system and related software that electronically transforms the license related data into several different types of visual depictions, including compliance logs, compliance updates, regulation updates and notifications of license requirements when hiring new employees or expanding the business, such as franchising the business, adding offices, expanding into new states and/or increasing diversity in the workplace.

### SUMMARY OF THE SUBJECT MATTER

A license tracking system has been developed that comprises: a) at least one set of license requirements, b) at least one form, questionnaire, prompt series, survey interface or combination thereof that requests at least one piece of input data related to a licensee, the license requirements or a combination thereof from a user, c) at least one database that collects and compares the at least one set of license requirements and the at least one piece of input data to produce a set of compliance instances and a set of alert instances, d) a compliance notice component that provides the set of compliance instances to the user, and e) an alert notice component that provides at least one of the alert instances to the user.

A method of tracking licenses and license-related information has also been developed that comprises: a) providing at least one set of license requirements, b) providing at least one form, questionnaire, prompt series, survey interface or combination thereof that requests at least one piece of input data related to a licensee, the license requirements or a combination thereof from a user, c) providing at least one database that collects and compares the at least one set of license requirements and the at least one piece of input data to produce a set of compliance instances and a set of alert instances, d) entering at least one piece of input data related to a licensee, the license requirements or a combination thereof from a user e) producing a compliance notice component that provides the set of compliance instances to the user, and f) producing an alert notice component that provides at least one of the alert instances to the user.

Network systems capable of executing software programs comprising license tracking software are also disclosed herein.

### BRIEF DESCRIPTION OF THE FIGURES

FIG. 1 shows a detailed flow chart for a contemplated license tracker system.

### DETAILED DESCRIPTION

Surprisingly, a system and related software has been developed that electronically transforms the license related data into several different types of visual depictions, including compliance logs, compliance updates, regulation updates and notifications of license requirements when hiring new employees or expanding the business, such as franchising the business, adding offices, expanding into new states and/or increasing diversity in the workplace. Contemplated systems and related software allow the user to secure a plurality of licenses, track, notify the licensee of updates and new requirements and aid the licensee in complying with those original and new requirements.

Contemplated systems disclosed herein solve many of the problems in the field of license tracking and compliance monitoring by allowing the user and/or licensee to keep all information about current licenses in one place, while at the same time, using the tracking system to provide timely notices and alerts when the user and/or licensee's business changes, when the license and/or compliance standards change or a combination thereof. Traditional systems of obtaining licenses and tracking compliance standards have been onerous, expensive and in some cases, ignored because all of the different state and federal standards are complex and varied.

Specifically, a license tracking system has been developed that comprises: a) at least one set of license requirements, b) at least one form, questionnaire, prompt series, survey interface or combination thereof that requests at least one piece of input data related to a licensee, the license requirements or a combination thereof from a user, c) at least one database that collects and compares the at least one set of license requirements and the at least one piece of input data to produce a set of compliance instances and a set of alert instances, d) a compliance notice component that provides the set of compliance instances to the user, and e) an alert notice component that provides at least one of the alert instances to the user.

A contemplated license tracking system comprises at least one set of license requirements. As used herein, “license requirements” may comprise any original set or update of requirements, information and other documentation that a state government, state licensing board, federal government, federal licensing board or independent licensing board requires of its potential licensees, licensees and related businesses. A contemplated set of license requirements may comprise one update or change to the current set of license requirements or may comprise a plurality of updates and/or changes to the current set of license requirements. Additionally, a contemplated set of license requirements may comprise the original or initial set of requirements, information and other documentation required for a new or potential licensee.

Contemplated license tracking systems also comprise at least one form, questionnaire, prompt series, survey interface or combination thereof that requests at least one piece of input data related to a licensee, the license requirements or a combination thereof from a user, mortgage professional and/or licensed professional. This piece of a contemplated license tracking system is designed for the user, licensee or potential licensee to provide information to the tracking system. As used herein, the term “user” describes that person who may not be a mortgage professional (such as a mortgage lender, company or individual), a mortgage broker, mortgage license individual and/or loan officer, licensee or potential licensee, but who is tasked with providing information to the system. A contemplated user may be an information technology or IT employee, a human resources employee, a receptionist or another similar person within the company or organization.

As mentioned, contemplated license tracking systems comprise at least one database that collects and compares the at least one set of license requirements and the at least one piece of input data to produce a set of compliance instances and a set of alert instances. A contemplated database may include any suitable database, such as that which is produced by a program like Microsoft Access. The database or plurality of databases collects the at least one set of license requirements, collects the at least one piece of input data and compares the two in order to produce a set of compliance instances, a set of alert instances or a combination thereof. A contemplated “compliance instance” is a notice or communication provided to the user or licensee that a license requirement has been complied with and is therefore up to date. A contemplated “alert instance” is a notice or communication provided to the user or licensee that a license requirement has not been complied with, is out of date or will be out of date/out of compliance in the near future.

Another component of a contemplated license tracking system is a compliance notice component, which provides the set of compliance instances to the user. A similar component is the alert notice component that provides at least one of the alert instances to the user and/or licensee. Either or both of the at least one compliance instance or alert instance may be provided to the user at a graphical interface, such as a website, an electronic or paper report, an electronic mail or “E-mail”, a text message, an instant message, or any other suitable method that can be used to notify or alert the user and/or licensee.

Contemplated license tracking systems may be utilized on a network system, locally by using an executable software program or through a service provided over the internet or a similar system. It should be noted that there is an electronic transformation of the at least one set of license requirements and the at least one form, questionnaire, prompt series, survey interface or combination thereof that requests at least one piece of input data related to a licensee, the license requirements or a combination thereof from a user into a visual depiction of licenses held, license renewals, license and compliance deadlines, and other related information. It is also instructive to note that there is a physical transformation of the at least one set of license requirements and the at least one form, questionnaire, prompt series, survey interface or combination thereof that requests at least one piece of input data related to a licensee, the license requirements or a combination thereof from a user in a physical result that comprises a visual depiction of licenses held, license renewals, license and compliance deadlines, and other related information.

Contemplated license tracking systems and related methods also comprise the ability to automatically accept or accept after prompting downloads and/or compilation of updates provided from different states, federal entities or license boards. Contemplated license tracking systems are designed to provide the user, licensee or potential licensee with information as to updates on license and compliance updates, changes and other information. Also, contemplated license tracking systems are designed to be utilized with new employees and hires, new franchises and/or locations, and new states where business is being conducted. Appropriate questionnaires are presented to the user and/or licensee, and once the user/licensee has filled out one set of information on the updates—all of the license requirements are reviewed by the license tracking system, compliance notices and alert notices are prepared by the system, and compliance notice components, along with any alert notice components are provided to the user/licensee.

Contemplated license tracking systems comprise a unique utility that has yet to be something capable of being completely performed by the human mind—in other words—contemplated license tracking systems are transformative. The complex system of tracking current requirements, current information and providing compliance instances, alert instances, compliance notices and alert notices is something that has yet to be solved in the art before this contemplated system was developed.

A method of tracking licenses and license-related information has also been developed that comprises: a) providing at least one set of license requirements, b) providing at least one form, questionnaire, prompt series, survey interface or combination thereof that requests at least one piece of input data related to a licensee, the license requirements or a combination thereof from a user, c) providing at least one database that collects and compares the at least one set of license requirements and the at least one piece of input data to produce a set of compliance instances and a set of alert instances, d) entering at least one piece of input data related to a licensee, the license requirements or a combination thereof from a user e) producing a compliance notice component that provides the set of compliance instances to the user, and f) producing an alert notice component that provides at least one of the alert instances to the user. In some embodiments, once the at least one compliance notice, at least one alert notice or the combination thereof is produced, they are transmitted to the user, the licensee, the potential licensee or a combination thereof.

Contemplated license tracking systems and methods of tracking licenses and collections of license and compliance information may be presented in any suitable format—as mentioned earlier—in that the format does not define the contemplated embodiments.

### EXAMPLES

### Example 1

### LicenseTracker™ System

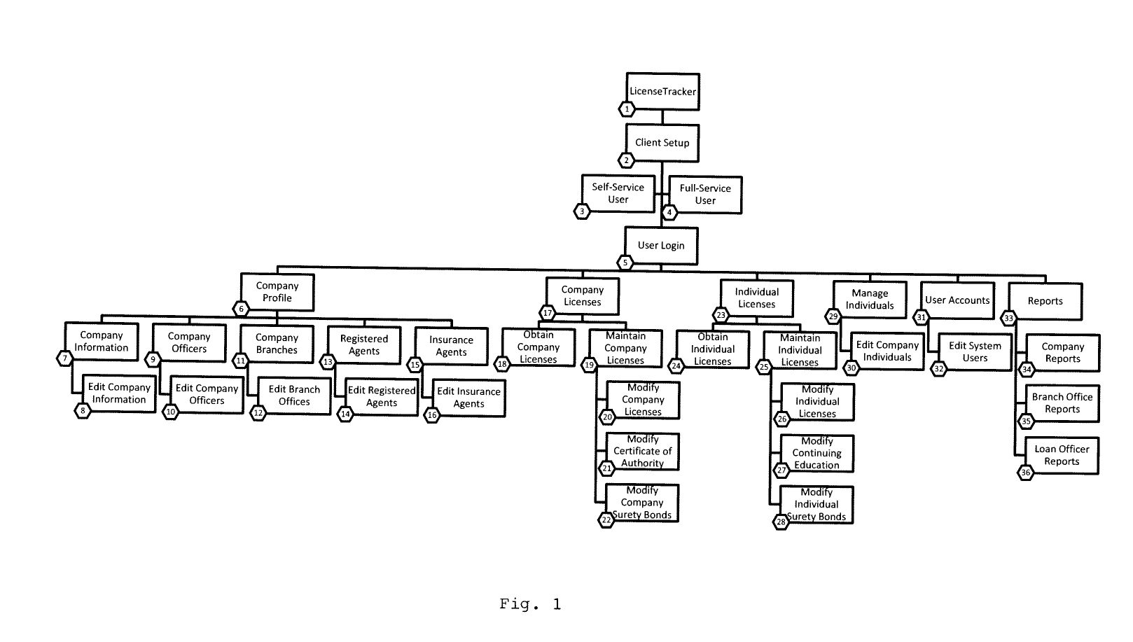

FIG. 1 shows a detailed flow chart for a contemplated license tracker system. This contemplated embodiment, shown as reference number 1, is designed to notify clients of their license deadlines and track the licensing process of each license on company, branch, and loan officer levels. It will help maintain licenses while staying synched and compliant with regulatory developments of each state. The flow chart of how this contemplated embodiment operates is described herein and below by referring to the reference numbers in FIG. 1.
2 Client Setup—Once a client agrees to utilize LicenseTracker and returns the signed contract, a setup technician or other similar entity, individual or system will perform the initial setup of the client. This initial client setup includes entering in the basic company information of the client and selecting which level of service the client requests.
3 Self-Service User—Level of service allowing the client full functionality of LicenseTracker. These users are responsible for maintaining their own licenses, and have full access to the system and are allowed to run reports, view, enter, modify, and delete their own company data in LicenseTracker.
4 Full-Service User—Level of service allowing the client limited functionality of LicenseTracker. These users contract with an individual, entity or other related system to maintain their licenses for them, have limited access to the system, and are only allowed to run reports and view their company data in LicenseTracker.
5 User Login—Once a client has been initially setup in LicenseTracker by an individual, entity or other related system and their level of service has been chosen, they are able to login to the system. Once logged into the system, they will be taken to the Company Profile section.
6 Company Profile—The company profile contains all the basic information regarding the client. This includes information on the company, its officers, branches, registered agents, and insurance agents.
7 Company Information—This section of the profile displays the pertinent information regarding the company. This information includes the name and DBA, main office address, telephone numbers, and stock information. To change any of this information, a client would hit the edit button.
8 Edit Company Information—When editing company information, a client can change their name and DBA, main office address, phone numbers, and stock information. When completed the save button has to be pressed so updated data is recorded in the system.
9 Company Officers—This section gives an overview of all the officers listed with the company and their positions. To add an officer, the client must click the “Add Officer” button. If officers are already in the list, just select their name to edit that information.
10 Edit Company Officers—The officer's information that can be edited in this section includes their name, amount of shares owned, personal information such as date of birth, citizenship, physical description, residential address, and contact information.
11 Branch Offices—This section of gives an overview of which branch offices the company has and the DBAs they are using. To add another branch, the client clicks the “Add Branch Office” button. To edit a branch's information, click on the name of the branch office.
12 Edit Branch Offices—Information that can be edited for the branch include the name and DBA, address, branch manager, and any additional contacts.
13 Registered Agents—This section lists all the registered agents and/or licensed professionals that the company uses. Clients can select a registered agent for their COA only if it appears in this list. To add a registered agent, click “Add Registered Agent,” and to edit one, just click on its name in the list.
14 Edit Registered Agents—The information on the registered agent's/licensed professional's main office can be edited here. This includes the name, address, and contact information.
15 Insurance Agents—This section lists all the insurance agents/licensed insurance professionals that the company uses. Clients can select an insurance agent for a bond only if it appears in this list. To add an insurance agent, click “Add Insurance Agent,” and to edit one, just click on its name in the list.
16 Edit Insurance Agents—The information on the insurance agent's/licensed insurance agent's main office can be edited here. This includes the name, address, and contact information.
17 Company Licenses—Once all the information on the company has been entered, this will be the new home screen when a client logs in. The colors of each state represent the status of the company in that state. To add or edit existing license information in the system, the client must click on the state for the information they want to enter. Green states indicate no actions need to be completed for that state at this time. Orange states indicate that an action needs to be completed for that state within 60 days. Red states indicate that an action needs to be completed for that state within 30 days. Yellow states indicate that a new license application is pending in that state.
18 Obtain Company Licenses—A client can request an individual, entity or other related system's services of applying for a license, by clicking the “Obtain New License” button. From here, they will be able to choose the state and license type they wish to apply for. The individual, entity or other related system will be notified and the process will begin. The individual, entity or other related system will also be able to use this section to update the client on the status of the license, and send requests. States with a pending license will be yellow in color.
19 Maintain Company Licenses—When a client clicks on a state, they will be taken to the License Detail for that state. This includes information on their company licenses, certificates of authority in each state they operate in, as well as any bonds they must hold in that state to stay compliant.
20 Modify Company Licenses—A client can click the “Add License” button to add a license to the system. They will be prompted for the type of license, license status, license number, issue date, and the due dates for their most recent filings required by the state for that license. Alternatively, they can click on a license that is already in the system to edit this information for an existing license.
21 Modify Certificate of Authority—A client can click the “Add Certificate of Authority” button to add a COA to the system. They will be prompted for the entity's ID number, registered agent, issue date, and the due dates for their most recent filings required by the state for that COA. Alternatively, they can click on a COA that is already in the system to edit this information for an existing COA.
22 Modify Company Surety Bonds—A client can click the “Add Bond” button to add a bond to the system. They will be prompted for the bond number, insurance agent, bond amount, monthly premium, issue date, and the expiration date. Alternatively, they can click on a bond that is already in the system to edit this information for an existing bond.
23 Individual Licenses—Once all the company's licenses have been entered, the can begin to add individual licenses to the system. The colors of each state represent the status of the company in that state To add or edit existing license information in the system, the client must click on the state for the information they want to enter. Green states indicate no actions need to be completed for that state at this time. Orange states indicate that an action needs to be completed for that state within 60 days. Red states indicate that an action needs to be completed for that state within 30 days. Yellow states indicate that a new license application is pending in that state.
24 Obtain Individual Licenses—A client can request an individual, entity or other related system's services of applying for a license, by clicking the “Obtain New License” button. From here, they will be able to choose the state and license type they wish to apply for. The individual, entity or other related system will be notified and the process will begin. The individual, entity or other related system will also be able to use this section to update the client on the status of the license, and send requests. States with a pending license will be yellow in color.
25 Maintain Individual Licenses—When a client clicks on a state, they will be taken to the Individual License Detail for that state. This includes names of the individuals licensed in that state, license numbers, status, license type, and location. The client also has the option of adding individuals here.
26 Modify Individual Licenses—A client can click the “Add License” button to add an individual license to that specific state. They will be prompted for the type of license, license status, license number, issue date, and the due dates for their most recent filings required by the state for that license. Alternatively, they can click on an individual's name, and have the ability to edit information for an existing license, including the continuing education and bond if required.
27 Modify Continuing Education—The systems knows how much continuing education is required for each license type, and the amount that an individual has completed should be added to the system. This will be a key item that the system looks at when sending out notifications.
28 Modify Individual Surety Bonds—A client can click the “Add Bond” button to add a bond to the system. They will be prompted for the bond number, insurance agent, bond amount, monthly premium, issue date, and the expiration date. Alternatively, they can click on a bond that is already in the system to edit this information for an existing bond.
29 Manage Individuals—This section will allow a client to add individuals (such as loan officers) that hold licenses to the system. To add an individual, the client must click the “Add Individual” button. If the Individual is already in the list, then the client only has to click that individual's name to edit the information. Only individuals who appear in this list will show up when trying to add an individual to a state.
30 Edit Company Individuals—The individual's information that can be edited in this section includes their name, personal information such as date of birth, citizenship, physical description, and residential address, and contact information.
31 User Accounts—This section gives an overview of all people who have authority to log into the system. A client can click “Add User” and setup another person to give them access to the system. Alternatively, a client can click on the name of a user already in the system and edit their permissions.
32 Edit System Users—Information that can be changed for a user includes their user name, password, name, job title, contact information, and permissions in the system.
33 Reports—This section breaks the reporting function down into different categories. Companies can run companywide reports, or narrow down to just their main office, branch offices, or down to an individual. These reports included status, due dates for filings, and even jurisdictions for offices and/or individuals.
34 Company Reports—These reports can either be companywide or to the main office specifically. They cover information on executive officers, branch offices, registered agents, insurance agents, company and individual licenses, COAs, bonds, and also information on the due dates for filings.
35 Branch Office Reports—These reports are specific to the branch offices and include information on the branch managers, branch licenses, COAs and bonds, and also information on the due dates for filings.
36 Loan Officer Reports—These reports are specific to individuals and detail their licenses, jurisdictions, continuing education, bonds, and also information on the due dates for filings.

Thus, specific embodiments, methods of a license tracking system and related software for complex license and compliance requirements have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A license tracking system, comprising:
at least one set of license requirements,
at least one form, questionnaire, prompt series, survey interface or combination thereof that requests at least one piece of input data related to a licensee, the license requirements or a combination thereof from a user,
at least one database that collects and compares the at least one set of license requirements and the at least one piece of input data to produce a set of compliance instances and a set of alert instances,
a compliance notice component that provides the set of compliance instances to the user, and
an alert notice component that provides at least one of the alert instances to the user.

2. The license tracking system of claim 1, wherein the at least one set of license requirements comprises an original set of requirement, an update of requirements, at least one piece of information, at least one piece of documentation or a combination thereof.

3. The license tracking system of claim 1, wherein the at least one set of license requirements is provided by or mandated by a state government, a state licensing board, a federal government, a federal licensing board, an independent licensing board or a combination thereof.

4. The license tracking system of claim 1, wherein the licensee comprises a mortgage professional, company or combination thereof.

5. The license tracking system of claim 1, wherein the at least one database comprises more than one database.

6. The license tracking system of claim 1, wherein the at least one database is generated by Microsoft Access.

7. The license tracking system of claim 1, wherein the user comprises an information technology employee, a human resources employee, a receptionist or a combination thereof.

8. The license tracking system of claim 1, wherein the set of compliance instances comprises a notice or communication.

9. The license tracking system of claim 1, wherein the set of alert instances comprises a notice or communication.

10. The license tracking system of claim 8, wherein the notice or communication contains information that a license requirement has been complied with and/or is up to date.

11. The license tracking system of claim 9, wherein the notice or communication contains information that a license requirement has not been complied with, is out of date, will be out of date in the near future or a combination thereof.

12. The license tracking system of claim 1, wherein the compliance instance or the alert instance may be provided at a graphical interface, an electronic report, a paper report, an electronic mail, a text message, an instant message or a combination thereof.

13. The license tracking system of claim 12, wherein the compliance instance or the alert instance is provided at a website, by an electronic mail or a combination thereof.

14. A method of tracking licenses and license-related information, comprising:
providing at least one set of license requirements,
providing at least one form, questionnaire, prompt series, survey interface or combination thereof that requests at least one piece of input data related to a licensee, the license requirements or a combination thereof from a user,
providing at least one database that collects and compares the at least one set of license requirements and the at least one piece of input data to produce a set of compliance instances and a set of alert instances,
entering at least one piece of input data related to a licensee, the license requirements or a combination thereof from a user,
producing a compliance notice component that provides the set of compliance instances to the user, and
producing an alert notice component that provides at least one of the alert instances to the user.

15. The method of claim 14, wherein providing at least one set of license requirements comprises providing an original set of requirement, an update of requirements, at least one piece of information, at least one piece of documentation or a combination thereof.

16. The method of claim 14, wherein the licensee comprises a mortgage professional, company or combination thereof.

17. The method of claim 14, wherein the user comprises an information technology employee, a human resources employee, a receptionist or a combination thereof.

18. The method of claim 14, wherein the set of compliance instances comprises a notice or communication.

19. The method of claim 14, wherein the set of alert instances comprises a notice or communication.

20. The method of claim 18, wherein the notice or communication contains information that a license requirement has been complied with and/or is up to date.

21. The method of claim 19, wherein the notice or communication contains information that a license requirement has not been complied with, is out of date, will be out of date in the near future or a combination thereof.

22. The method of claim 14, wherein the compliance instance or the alert instance may be provided at a graphical interface, an electronic report, a paper report, an electronic mail, a text message, an instant message or a combination thereof.

23. A network system comprising an executable software program, wherein the program comprises a license tracking system.
